(19) United States
(12) Patent Application Publication
(10) Pub. No.: US 2025/0344896 A1
(43) Pub. Date: Nov. 13, 2025

(54) PORTAFILTER WITH A USED COFFEE EXTRACTION SILENT MECHANISM

(71) Applicants: Haviv LEVI, Lod (IL); Yael LEVI, Lod (IL)

(72) Inventors: Haviv LEVI, Lod (IL); Yael LEVI, Lod (IL)

(21) Appl. No.: 19/275,693

(22) Filed: Jul. 21, 2025

Related U.S. Application Data
(63) Continuation of application No. PCT/IL2024/050068, filed on Jan. 17, 2024.
(60) Provisional application No. 63/440,419, filed on Jan. 22, 2023.

(51) Int. Cl. A47J 31/06; A47J 31/60

(52) U.S. Cl. CPC A47J 31/0657; A47J 31/60

(57) ABSTRACT

The present invention discloses a portafilter with a silent used-coffee extraction integrated mechanism for basket cleaning, comprising a handle interconnected with a basket via neck portion, said basket comprising a sidewall, a bottom and an open top; characterized by at least a portion of said bottom being movable, said bottom being in communication with a spring-loaded lever, said bottom being transferable from a bottom portion of said sidewall towards a top portion of said sidewall by said lever.

### FIELD OF THE INVENTION

The present invention pertains to a portafilter with a used coffee extraction silent mechanism and modules thereof, to methods of manufacturing and using the same.

### BACKGROUND OF THE INVENTION

In the rich tapestry of human history and diverse cultures worldwide, coffee has been a cherished beverage for millennia. Its global proliferation accelerated significantly during the industrial and sea transportation revolutions, weaving its aromatic tendrils into the fabric of societies across the globe. Today, coffee is not merely a beverage; it has metamorphosed into a cultural phenomenon, an integral part of countless individuals' daily routines.

Coffee machines, once exclusive to cafes and restaurants, have permeated private spaces, finding a home in many households. Amidst this cultural backdrop, a groundbreaking and innovative solution emerges a conceptual marvel that seamlessly integrates existing components, technologies, and elements. This ingenious method, concept, or product stands as a testament to originality, offering a practical and unique solution.

A portafilter is a component of a coffee machine, such as an espresso maker, in which ground espresso beans or coffee grounds are held prior to and during the brewing process. The espresso flavour is extracted from the coffee grounds as hot water runs through the portafilter, which includes a filter such as a coffee basket before being dispensed into a coffee basket, positioned below the portafilter, see US20060288875, US20090260522 and US20190133369.

The coffee residue is cleaned from the portafilter in preparation for its next use through the use of buckets or knock-boxes. In order to remove the coffee residue, the portafilter is nocked, namely repeatedly impacted against a bucket to release the coffee residue which often includes a coffee puck which forms in the coffee basket.

As per the details provided in GB2593219, the drawbacks of the conventional method extend beyond the evident issues of loud noises and potential damage to both the portafilter and the knock-box. There are additional concerns related to the health and safety of the user. The typical noise emitted is loud, e.g., up to about 105 dB. experts estimate that noise levels above 105 decibels can damage hearing, if endured for more than 15 minutes each week. Keep in mind that even noise levels between 85 and 90 decibels can cause permanent damage.

Primarily, the repetitive impact of the portafilter against the knock-box poses a risk of wrist injury for users, especially baristas in high-volume environments such as coffee shops. The frequent and forceful actions involved in making tens or hundreds of coffees per day can increase the likelihood of developing repetitive strain injuries, placing an undue strain on the user's wrists.

Secondly, the residual coffee residue in the portafilter cavity, even after deploying the knockbox, typically necessitates cleaning with a cloth. This additional step introduces a potential risk of contamination, as the cloth may carry unwanted substances that could compromise the hygiene of the portafilter and, consequently, the quality of the brewed coffee.

In summary, the traditional method not only presents practical challenges but also raises significant health and safety concerns for users, particularly those engaged in high-volume coffee preparation. Referring back to GB2593219, it is emphasized that incomplete cleaning of coffee residue may have adverse effects on the subsequent flavor when using the portafilter. Additionally, the potential damage incurred by repeated impacts with a knock-box can lead to compromised scaling performance. In subsequent uses, the portafilter, when installed in the coffee machine, may fail to deliver the desired level of performance.

Given the undesirability of the repeated impact method, alternative solutions have been proposed for extracting used coffee from the basket. These include the utilization of a rotating brush, as exemplified by patents such as EP3158901, EP2732742, AU2016368528, WO2019074448, DE202021101888, DE102016211375, and US20230157481. In these solutions, a cleansing brush is employed, and its rotation facilitates the removal of used coffee from the basket. The rotating brush and bristles thereof touch the sidewalls of the basket, and abrase the surface of the delicately-made walls, some are coated with thin polymeric or metal layer.

Another suggested approach involves a cleaner featuring a main body with a motor-driven unit, rotating with an external power supply, and a holder that securely holds a portafilter combined with a filter basket, as described in KR101395950. Further innovations include a cleaner equipped with a vacuum source and air or steam pressuring means, as outlined in W02020000045 and WO2018106592. These methods leverage advanced mechanisms to effectively clean the portafilter, offering alternatives to the traditional and potentially hazardous impact-based approach. U.S. Pat. No. 11,197,578B2 discloses a backflush cleaning container designed for attachment to an espresso machine's group head. The container facilitates the backflushing process, ensuring effective cleaning of the group head, valve, and multiple tubes with water. Key components include a body with an interior cavity for holding water, a piston enabling variable volume adjustments for backflushing, and a spring mechanism to bias the piston for efficient operation. The invention aims to provide a reliable and improved method for maintaining the cleanliness of espresso machines, particularly focusing on the crucial components involved in the brewing process.

The present invention aims to furnish a solution for non-X-axis rotating and abrasing portafilter cleaning, mitigating the issues previously outlined. This is achieved through the incorporation of a specialized portafilter cleaning head, which may constitute a component of a larger portafilter cleaning apparatus, namely being integrated with a commercially available portafilter, forming hence an integral part of a comprehensive portafilter cleaning unit, or serving as a viable alternative for users.

### SUMMARY OF THE INVENTION

It is hence an object of the invention to disclose a portafilter with a noiseless, namely not loud than 75 dB, used-coffee extraction mechanism for basket cleaning, comprising a handle interconnected with a basket via neck portion, the basket comprising a sidewall, a bottom and an open top; characterized by at least a portion of the bottom being movable, the bottom being in communication with a spring-loaded lever, the bottom being transferable from a bottom portion of the sidewall to a top portion of the sidewall by the lever.

Noise over 85 dB for extended periods can cause permanent hearing loss; reference is made to Abatement of Nuisances Israel Law, 5721-1961, and its Regulations. Hence, another object of the invention is to disclose the portafilter as defined above, wherein the side-wall-nonabrasive, silent (75 dB or less, a noise level which is not dangerous over 30 minutes) used-coffee extraction mechanism for basket cleaning is an integrated with the portafilter. Another object of the invention is to disclose the portafilter as defined above, wherein the bottom is transferable automatically from the top portion of the sidewall to the bottom portion of the sidewall by a spring of the spring-loaded lever.

Another object of the invention is to disclose the portafilter as defined in any of the above, wherein at least partially made of chrome plated brass, or a metalware coated with fluoropolymer or other Teflon™-like materials.

Another object of the invention is to disclose the portafilter for a noiseless used-coffee extraction mechanism designed for coffee-basket cleaning. The portafilter comprising a handle interconnected with a basket via neck portion. The basket features a sidewall, a bottom, and an open top. Notably, a portion of the bottom is movable, and the movable bottom is in communication with a spring-loaded lever. The configuration enables the transfer of the bottom from a bottom portion to a top portion of the sidewall by the lever.

Another object of the invention is to disclose the portafilter where the bottom portion is manually, semi-automatically or automatically transferable from the top portion to the bottom portion of the sidewall, facilitated by a spring within the spring-loaded lever.

Another object of the invention is to disclose the portafilter where the noiseless used-coffee extraction mechanism for basket cleaning mechanism is characterized by that, in conjunction with the spring-loaded lever, it provides a quiet and efficient solution for used-coffee extraction and basket cleaning in coffee preparation equipment.

Another object of the invention is to disclose a method of used-coffee extraction and basket cleaning silent mechanism, comprising providing a portafilter with a handle interconnectable with a basket via a neck portion; providing the basket with a sidewall, a bottom and an open top, wherein at least a portion of the bottom is movable upwards; providing the bottom portion in communication with a thumb-operated spring-loaded lever, and configuring the same so that the bottom is able to reversibly reciprocate from a low most location of the basket to a top most of the basket.

Another object of the invention is to disclose a method and mechanism for used-coffee extraction and basket cleaning in a portafilter, comprising the steps of providing a portafilter equipped with a handle that is interconnectable with a basket via a neck portion; furnishing the basket with a sidewall, a bottom, and an open top, wherein at least a portion of the bottom is movable upwards; establishing communication between the movable bottom portion and a thumb-operated spring-loaded lever; and configuring the thumb-operated spring-loaded lever in a manner allowing the bottom portion to reversibly reciprocate from a low most location of the basket to a top most of the basket.

Another object of the invention is to disclose the portafilter wherein said side wall has an engagement flange or protuberance (121a) for engaging with the coffee making machine.

Another object of the invention is to disclose the portafilter wherein the side wall has an engagement portion for mating with the coffee making machine selected from the group consisting of groove, spline, slot or any other indentation for engaging with the coffee making machine.

Another object of the invention is to disclose the portafilter wherein the basket is in part or in whole, any polygonal shape.

Another object of the invention is to disclose the portafilter wherein said basket is in part in in whole, any curvilinear shape such as a curved funnel with parallel sides, or a funnel with nonparallel sides.

Another object of the invention is to disclose a method as defined above, wherein the basket's bottom portion is selectively movable upwards, facilitating efficient used-coffee extraction and basket cleaning.

Another object of the invention is to disclose a method as defined above, wherein the thumb-operated spring-loaded lever enables a user-friendly and ergonomic operation for the reversible reciprocation of the bottom portion.

Another object of the invention is to disclose a method as defined above, wherein the basket's design promotes both noiseless cleanliness in coffee preparation equipment and basket nonabrasive and case of maintenance.

Another object of the invention is to disclose a method as defined above, wherein the movable bottom portion's reversible reciprocation from a low most location to a top most of the basket enhances the efficiency of the used-coffee extraction process.

Another object of the invention is to disclose a method as defined above, wherein the configuration of the thumb-operated spring-loaded lever ensures a silent, controlled, precise and non-abrasive movement of the bottom portion during the basket cleaning process.

### BRIEF DESCRIPTION OF THE FIGURES

Reference will now be made to the accompanying drawings, which are not necessarily drawn to scale:

FIGS. 1a-1b schematically illustrate a side view (intact and as across sections) of an embodiment of a portafilter equipped with a used-coffee extraction mechanism is schematically presented. The portafilter includes a handle connected to a basket through a neck portion. The basket is characterized by a sidewall, a movable bottom, and an open top. Notably, the movable bottom is integrally linked to a spring-loaded lever, enabling its smooth transition from a lower position within the sidewall to an upper position;

FIGS. 2a and 2b illustrate perspective views of specific, non-limiting embodiments of the invention;

FIGS. 3a to 3d illustrate optional sizes and dimensions of the device and components thereof;

FIGS. 4a to 4e illustrate intact and explode views of an embodiment of the portafilter;

FIGS. 5a to 5c illustrate a portafilter according to an aspect of the invention; and

FIGS. 6a and 6b depict the different axes of the device.

### DETAILED DESCRIPTION OF THE PREFERRED EMBODIMENTS

The inventive disclosure encompasses a unique portafilter design, offering enhanced functionality through a movable bottom and spring-loaded lever mechanism, as well as presenting varied embodiments to illustrate the versatility of the invention. in this invention, a “barista” is an individual specializing in the preparation of espresso coffee and its various iterations, such as macchiatos, cappuccinos, or lattes. An “espresso coffee grinder” is a device that transforms roasted coffee beans into ground coffee suitable for making coffee, espresso, or related beverages. The resultant ground coffee is placed into the basket of a “portafilter,” a component in traditional espresso preparation methods. The portafilter is then inserted into an espresso machine, where hot water is pressurized and directed through the basket of the portafilter as in 124. This process yields espresso coffee, commonly known as “espresso,” “espresso shots,” or “espresso drinks.”

The term “silent” refers to a noiseless of no more than about 75 dB and for sure much less than 105 dB noise of the current devices, free of a knocking sound mechanism usually accompanying the cleaning the interior volume of the basket from coffee after its use in commercially available portafilters.

The invention pertains to the field of coffee preparation equipment, specifically focusing on barista spoons (i.e., a portafilter) used in professional coffee machines. The technology disclosed herein depicts an innovative barista spoon cleaning mechanism and method for its use and assembly. A novel solution is addressing the disruptive noise generated during the cleaning of barista spoons in cafes and restaurants. The innovation combines various products and integrates technology to create a unique mechanism for efficiently and quietly cleaning barista spoons after use. The invention offers a practical and original method for making coffee in a quiet and gentle manner, enhancing the overall cafe experience.

Barista spoon cleaning creates disruptive noise and harms the barista and the surroundings. Existing cleaning methods lack the efficiency of the current patent. Solutions known in the art, such as rotating brush, harm the spoon and abraid its surface. Hence the suggested technology provides a quiet and efficient barista spoon cleaning. The mechanism is small, cost effective, simple, and convenient for easy operation. The technology of the invention enables a noiseless and very effective cleaning process for barista spoons.

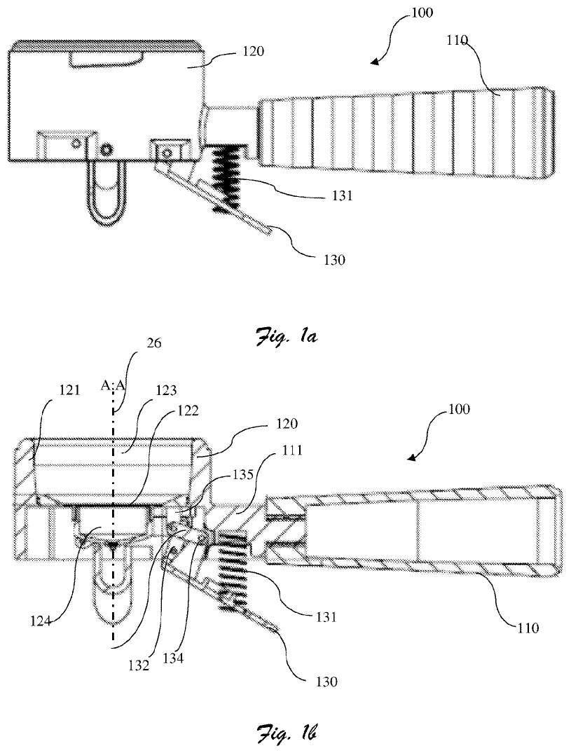

Reference is now made to FIGS. 1a-5c. In accordance with the present invention, as depicted in FIGS. 1a-1b, an embodiment of a portafilter (100) with a used-coffee extraction silent mechanism is disclosed schematically in side view and lateral cross section, respectively. The portafilter comprises a handle (110) coupled to a basket (120) via a neck portion (111). The basket features a sidewall (121), a movable bottom (122), and an open top (123). Importantly, the movable bottom is operatively connected to a spring-loaded lever (130), facilitating its transfer from a lower position within the sidewall to an upper position. The sidewall (121) may have an engagement flange (121a) to engage, and keep pressure, with the coffee making machine by, for example mating with a complementary portion of the coffee making machine. In some embodiments of the invention the engagement flange is not present but is instead a groove, a spline or slot or any other coffee making machine engagement portion.

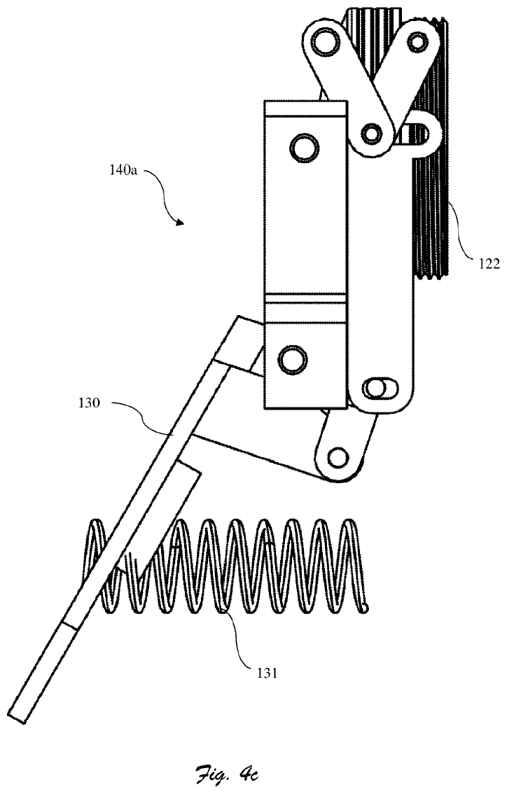

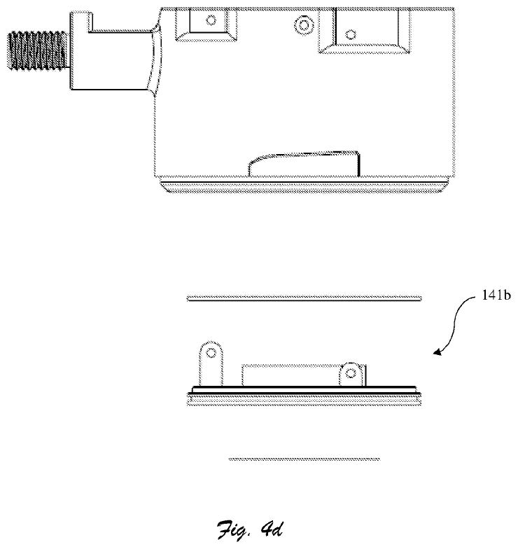

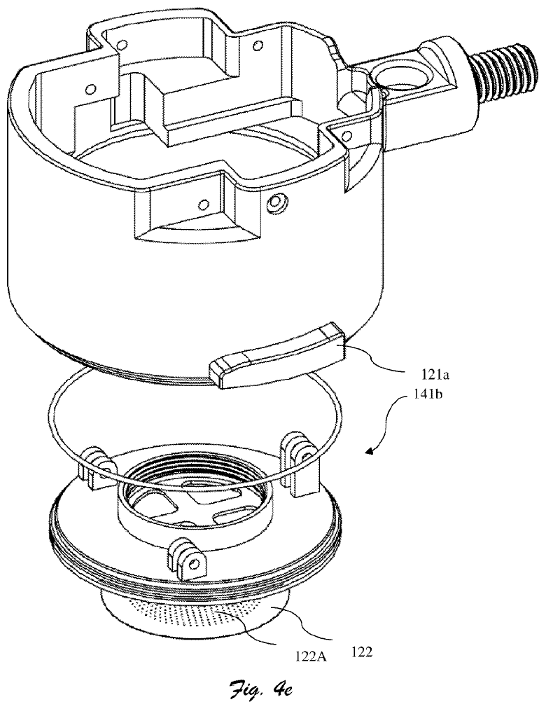

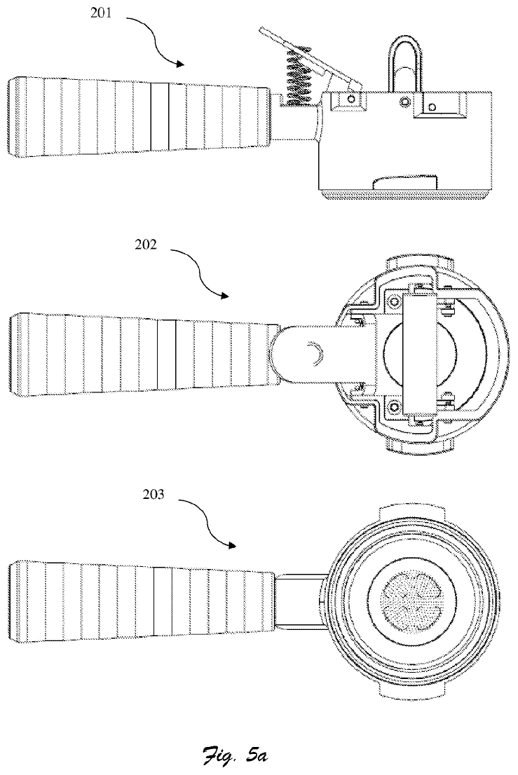

Reference is made to some embodiments of the invention wherein the basket (120) may be of, in part or in whole, any polygonal shape such as a hexagon. In some embodiments of the invention the basket may be in part or in whole, any curvilinear shape such as a curved funnel with parallel sides, or a funnel with non-parallel sides. Referring again to the figures section, the used-coffee extraction and basket cleaning mechanism may comprise a knob 130 loaded by a spring, 131. Alternatively, knob 130 (e.g., switch or controller) is an operating button, or an activation member of a linear translation, e.g., rack and pinion or screw in bolt mechanisms, rotary translation mechanism, electric engine, hydraulic or pneumatic mechanisms etc. Mechanical mechanism may comprise levers and axles, such those depicted in FIG. 1b (members 130-135), in FIG. 4a and FIG. 4c, namely assembled bottom activation mechanism 140a, and disassembled mechanism in an exploded views 140b and bottom related parts 141b in FIG. 4d and FIG. 4c. Optionally, handle 110 is an elongated member made of wood, plastic or metalware, having a distal end 110b and proximal end 110a where the handle is affixed to the basket 120. The bottom of a portion thereof may be perforated as a filter avoiding solids to flow.

The movement of the basket's bottom is operated manually, semi-automatically, or automatically, transitioning from the top to the bottom portion through e.g., assistance of a spring (131) integrated into the spring-loaded lever (130).

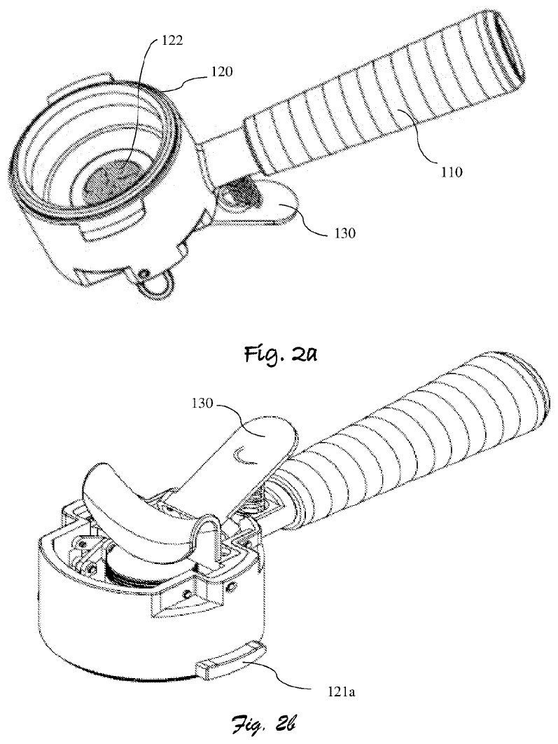

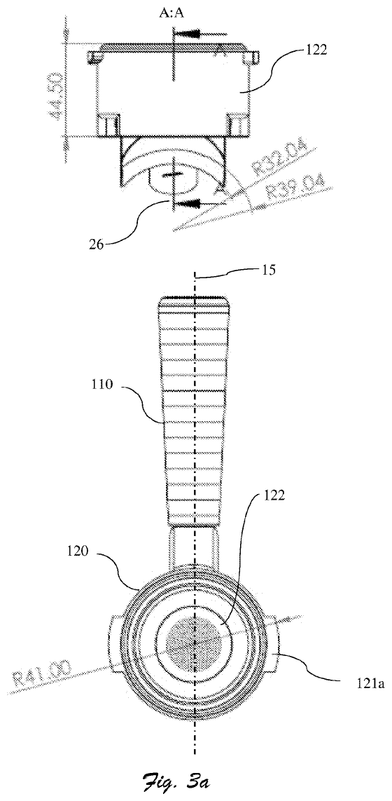

FIGS. 2a and 2b illustrate perspective views of specific, non-limiting embodiments of the invention in a schematic manner, showcasing diverse configurations and applications.

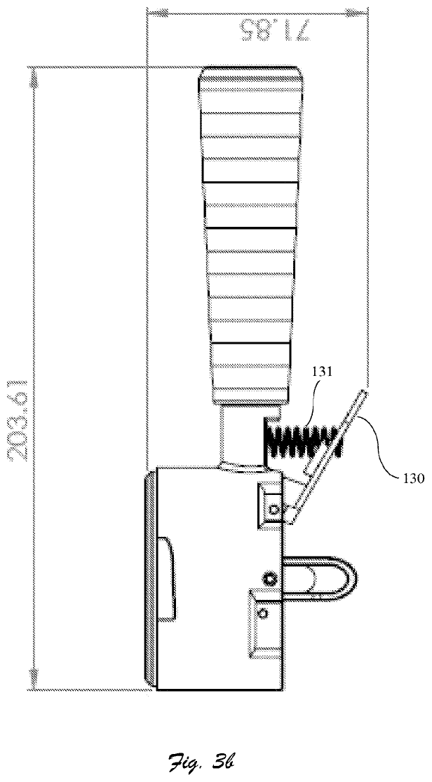

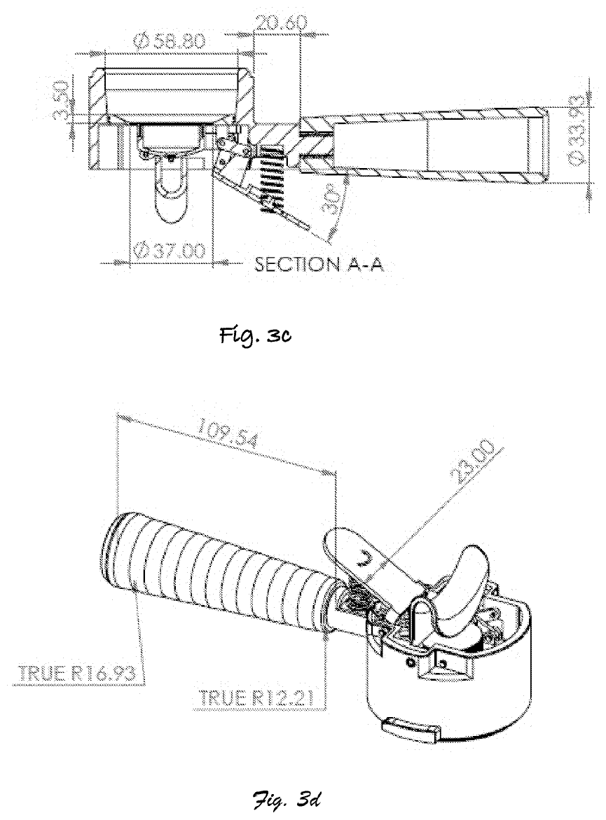

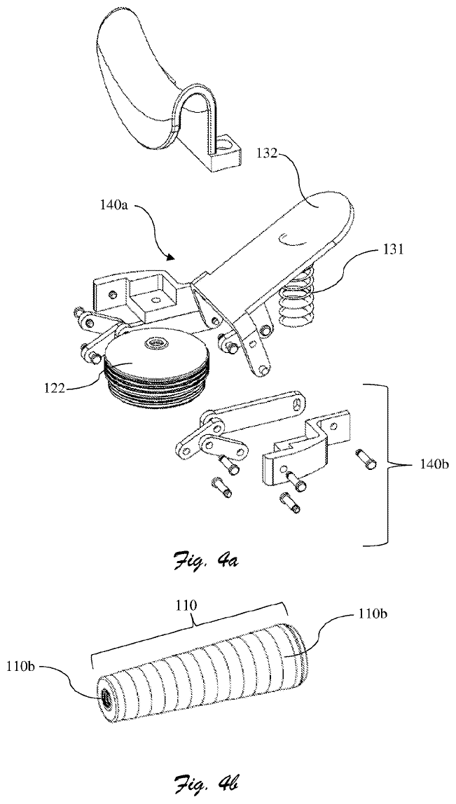

FIGS. 3a to 3d illustrate an embodiment of the portafilter for noiseless used-coffee extraction and basket cleaning. The drawing shows optional sizes and dimensions of the device and components thereof.

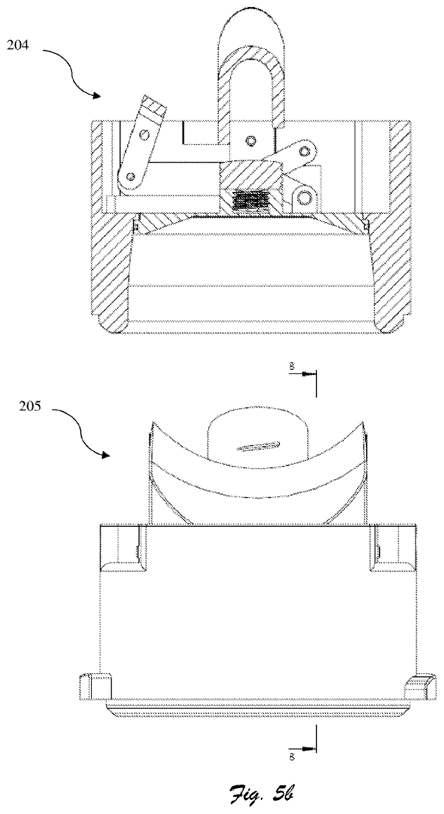

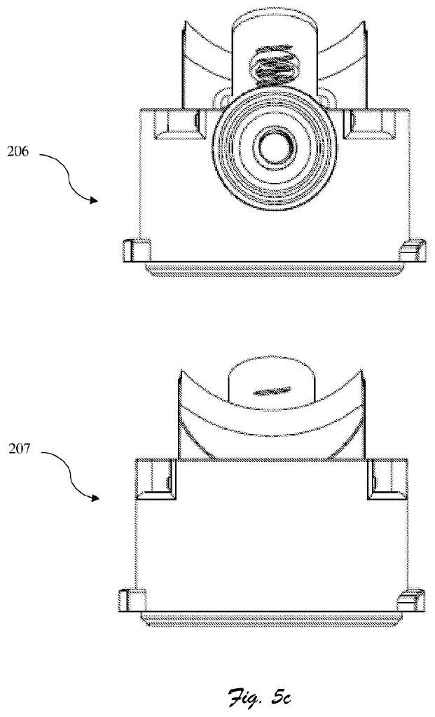

FIGS. 4a to 4e illustrate explode views of an embodiment of the portafilter and its used-coffee extraction and basket cleaning mechanisms. FIGS. 5a to 5c illustrate views 201 to 207. Views 201 to 203 depict a portafilter according to one aspect of the invention, namely side view, bottom view and top view, respectively. Views 204 and 205 show cross section of the basket and intact side view of the proximal side of the same. Views 206 and 207 show the basket from its distal side, i.e, one connected with handle 110.

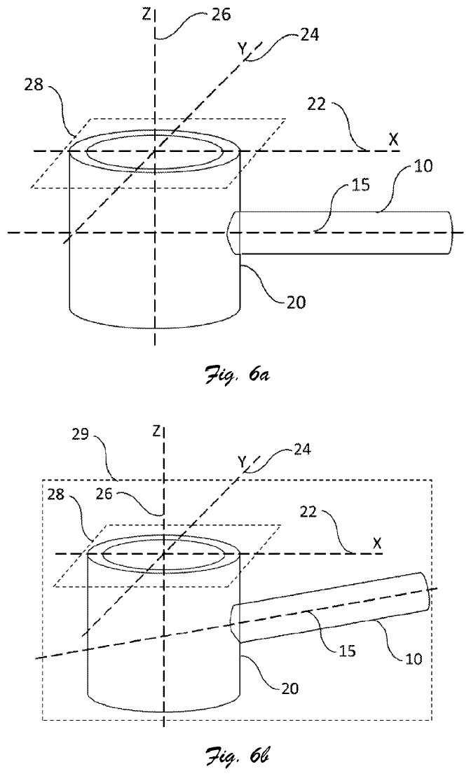

FIGS. 6a and 6b depict Z axis (26) is the cylinder axis of the basket (20). The X axis (22) is in the plane (28) of the top of the basket (20) and is perpendicular to the cylinder axis of the basket (26). Typically, the longitudinal axis of the handle (15) is perpendicular to the cylinder axis (26) of the basket (20). In such embodiments, the X axis (22) is parallel to the longitudinal axis (15) of the handle (10). The Y axis (24) is perpendicular to the X (22) and Z (26) axes. In some embodiments, the longitudinal axis (15) of the handle (10) is tilted upward or downward relative to the plane (28) of the top of the basket (20). In these embodiments, the longitudinal axis (15) of the handle (10) and the cylinder axis (26) of the basket (20) are in a plane (29) and the X axis (22) is perpendicular to the cylinder axis (26) of the basket and is in the plane defined by the longitudinal axis (15) of the handle (10) and the cylinder axis (26) of the basket (20). The Y axis (24) is perpendicular to the X (22) and Z (26) axes.

Waste coffee ejectors of the prior art discloses a brush with bristles thereof, rotating within the basket along Z axis (26). None of the published mechanisms comprises a rotating-ejector actuated along either X axis (22) or Y axis (24) of the basket. Hence, and according to yet another embodiment of the invention, the mechanism comprises a pivotal waste-coffee ejector mechanism mounted on the handle, e.g., adjacent to the juncture. This mechanism incorporates an arcuate tongue projecting into the coffee-containing basket, the outward-facing surface of which conforms to the interior surface of the basket. Additionally, a short thumb lever arm is integrally formed on the ejector at the opposing end of the tongue. Positioned on the handle side of the juncture and extending above the handle, this thumb lever arm is designed for depression by the user's thumb into the short opening. This action actuates the ejector, causing the tongue to rotate along either X axis (22) or Y axis (24) and elevate from the bottom of the basket, thereby facilitating an easy and non-abrasive ejection of wasted coffee. Importantly, the ejector is spring-biased to return the tongue to a bottomed position within the basket, and a majority of the handle is designed for convenient gripping during attaching the portafilter to the espresso machine, without necessitating ejector engagement. Optionally, a distinctive aspect of the basket design involves the incorporation of an exterior imperforate arcuate protrusion, resulting in a shallow interior arcuate recess located in the bottom of the basket. This recess and protrusion align with the ejector and are configured to receive the back surface of the tongue when the tongue is bottomed in the basket. The depth of the recess is such that, when the tongue is bottomed within the recess, the outward-facing surface of the tongue forms a substantially hemispherical continuum with the interior surface of the basket. Moreover, the recess extends along the basket at least to the juncture of the basket and handle, creating stepped ribs adjacent to the recess that are integrally connected to the handle.

The technology of the present invention also discloses methods and mechanisms associated with used-coffee extracting and basket cleaning. The methods comprise steps of providing a portafilter (100) with a handle (110) interconnectable with a basket (120) through a neck portion (111); providing the basket (120) with sidewall(s), a bottom (122), with a filter portion 122a, and an open top (123). The bottom (122) or a portion thereof is engineered to be movable. It is mechanically connected with a thumb-operated spring-loaded lever (130). By pushing or otherwise actuating the lever, the bottom is reversibly reciprocating between a lower location within the basket to a higher location within the basket.

Method of coffee extraction may comprise the following steps: (a) depositing used coffee grounds in the basket. The movable bottom portion (122) is positioned at the bottom of the basket along the brewing of the coffee. Upon completion of the brewing, basket cleaning is provided by activating a thumb-operated lever (130), hence triggering a reversible reciprocation of the bottom portion (122). The bottom portion of the basket (122) is moving from a lowermost location to a topmost location within the basket, efficiently extracting used coffee grounds and simplifying the cleaning process.

The advantages of this cleaning mechanism and method of use coffee extraction is that it enable quick, silent and effective extraction of used coffee grounds. It simplifies the cleaning process with the reversible reciprocation of the bottom portion. The thumb-operated lever provides a convenient and ergonomic means of operation.

Barista operations, enabled by the technology of the invention, are as follows: Loading coffee into the barista spoon; Compressing coffee to desired levels; Placing the spoon in the coffee machine; Activating the machine for coffee preparation; and then, after coffee extraction, the innovative cleaning mechanism is applied to the portafilter. Cleaning steps are as follows: the cleaning mechanism, whether mounted or integrated, is activated; residual coffee contents are efficiently removed and the barista spoon is ready for a subsequent use.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A portafilter, comprising:
a basket having a sidewall, a bottom and an open top, at least a portion of said bottom being movable relative to the sidewall; and
an extraction mechanism being operatively connected to the basket and being operable for moving said movable portion of the bottom upwards along the sidewall.

2. The portafilter of claim 1, wherein said movable portion of said bottom is reversibly reciprocable between a lower position along the sidewall to an upper position along the sidewall, the upper position being higher relative to the lower position.

3. The portafilter of claim 1, wherein the extraction mechanism is in continuous operative connection with the basket and is fixedly connected thereto, directly or indirectly.

4. The portafilter of claim 1, wherein the extraction mechanism comprises a lever configured to push the movable portion of the bottom to move it upwards along the sidewall when the lever is actuated.

5. The portafilter of claim 4, wherein the extraction mechanism comprises a spring being configured to allow return of the lever after actuation, causing the movable portion of the bottom to move downwards along the sidewall.

6. The portafilter of claim 5, wherein the movable portion of the bottom is transferable automatically towards a lower position of said sidewall by the spring.

7. The portafilter of claim 5, further comprising a handle interconnected with the basket via a neck portion and the spring is affixed to the neck portion.

8. The portafilter of claim 5, wherein said spring and lever are configured to emit less than 75 Db during operation measured at a distance equivalent to an average barista's ear and said portafilter during operation.

9. The portafilter of claim 1, wherein said sidewall has an engagement flange or protuberance for engaging the portafilter with a coffee making machine.

10. The portafilter of claim 9, wherein said sidewall has an engagement portion for mating with a coffee making machine, the engagement portion selected from the group consisting of a groove, spline, slot or any other indentation for engaging with the coffee making machine.

11. A portafilter comprising:
a basket having a sidewall, a bottom and an open top, at least a portion of said bottom being selectively movable relative to the sidewall; and
an extraction mechanism comprising a spring-loaded lever operatively connected to the basket and being operable for moving said selectively movable portion of the bottom upwards along the sidewall by actuation of the spring-loaded lever.

12. The portafilter of claim 11, wherein the spring-loaded lever is assembled to a handle of the portafilter.

13. The portafilter of claim 11, wherein the spring-loaded lever is positioned adjacent to the handle such that the spring-loaded lever is configured to be actuated by a user while the user is holding the handle.

14. The portafilter of claim 11, wherein the spring-loaded lever has a spring which biases the spring-loaded lever toward a rest position following actuation.

15. The portafilter of claim 11, wherein the selectively movable portion of the bottom is reciprocable between a lower position and an upper position within the basket.

16. The portafilter of claim 11, wherein the extraction mechanism remains in fixed operative connection with the basket during operation.

17. A method of operating a portafilter comprising a basket having a sidewall, a bottom, and an open top, wherein at least a portion of the bottom is movable relative to the sidewall, the method comprising:
actuating an extraction mechanism that is operatively connected to the basket to move the movable portion of the bottom upward along the sidewall,
wherein the upward movement facilitates extraction of used coffee grounds and cleaning of the basket.

18. The method of claim 17, further comprising returning the movable portion of the bottom to a lower position along the sidewall by reverse movement.

19. A method of operating a portafilter comprising a basket having a sidewall, a bottom, and an open top, wherein at least a portion of the bottom is movable relative to the sidewall, and an extraction mechanism comprising a spring-loaded lever operatively connected to the basket, the method comprising:
actuating the spring-loaded lever to move the movable portion of the bottom upwards along the sidewall,
wherein the upward movement facilitates extraction of used coffee grounds and cleaning of the basket.

20. The method of claim 19, wherein the spring-loaded lever is actuated by the hand of a user while holding the handle.
